(19) United States
(12) Patent Application Publication
(10) Pub. No.: US 2010/0033131 A1
(43) Pub. Date: Feb. 11, 2010

(54) PORTABLE DEVICE AND CONTROL METHOD THEREOF

(75) Inventor: Dae-hyeon KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/407,870

(22) Filed: Mar. 20, 2009

(30) Foreign Application Priority Data
Aug. 11, 2008 (KR) 2008-78549

(51) Int. Cl. H02J 7/00

(52) U.S. Cl. 320/134

(57) ABSTRACT

Disclosed is a portable device which includes: a battery, a temperature determining unit which determines a temperature of the portable device, a temperature of the battery and a temperature of external air; a power unit which receives power from the battery and applies the power to the portable device; and a central processing unit which controls the power unit to cut off power to the portable device, based on at least one of the temperatures determined by the temperature determining unit, thereby preventing accidents when using the portable device.

### CROSS-REFERENCE TO RELATED APPLICATIONS

This application claims priority from Korean Patent Application No. 10-2008-0078549, filed on Aug. 11, 2008, in the Korean Intellectual Property Office, the disclosure of which is incorporated herein by reference in its entirety.

### BACKGROUND OF THE INVENTION

1. Field of the Invention

Apparatuses and methods consistent with the present general inventive concept relate to a portable device and a control method thereof, and more particularly, to a portable device using a battery, which prevents an accident, and a control method thereof.

2. Description of the Related Art

Due to portability of a portable device, a power supply thereof is limited. Thus, the portable device is used with a chargeable battery to solve the problem of limited power supply.

Meanwhile, the portable device tends to have numerous integrated circuits (ICs) therein as its performance and capabilities improve. In this case, the ICs may generate excessive heat while operating at high speeds. Thus, the prevention of an accident due to high temperatures is a concern regarding portable devices which employ batteries, such as a laptop computer.

### SUMMARY OF THE INVENTION

The present general inventive concept provides a portable device which prevents an accident such as a battery explosion, and a control method thereof.

Additional features and utilities of the present general inventive concept will be set forth in part in the description which follows and, in part, will be obvious from the description, or may be learned by practice of the present general inventive concept.

Embodiments of the present general inventive can be achieved by providing a portable device which receives power from a battery. The portable device may include a temperature determining unit which determines a temperature of the portable device, a temperature of the battery and a temperature of external air, a power unit which receives power from the battery and applies the power to the portable device, and a central processing unit which controls the power unit to cut off power to the portable device, based on at least one of the determined temperatures.

The temperature determining unit may directly determine the temperature of the battery or indirectly determine the temperature of the battery received through a communication between the central processing unit and the battery.

The central processing unit may control the power unit to cut off power supplied to the portable device if the temperature of the external air is greater than or equal to a preset temperature.

The central processing unit may control the power unit to cut off power supplied to the portable device if the temperature of the portable device or the temperature of the battery is equal to or greater than a critical temperature.

The central processing unit may control the power unit to cut off power supplied to the portable device if at least one of temperature changes in the portable device, the battery and the external air per unit time is greater than or equal to a preset reference value.

The central processing unit may control the battery to stop being charged or discharged depending on at least one of the determined temperatures.

Embodiments of the present general inventive concept can also be achieved by providing a system which has a battery and a portable device that may include a portable device which determines a temperature of the portable device, a temperature of the battery and a temperature of external air, and controls the battery to stop being charged or discharged depending on at least one of the determined temperatures; and a battery which supplies power to the portable device, and stops being charged or discharged according to a control of the portable device.

The portable device may cut off power based on at least one of the determined temperatures.

Embodiments of the present general inventive concept can also be achieved by providing a control method of a portable device which receives power from a battery that may include determining a temperature of the portable device, a temperature of the battery and a temperature of external air, and cutting off power to the portable device based on at least one of the determined temperatures.

The determining of the temperature of the battery may include directly determining the temperature of the battery, or indirectly determining the temperature of the battery received through communication between a central processing unit and the battery.

The power supplied to the portable device may be cut off if the temperature of the external air is greater than or equal to a preset temperature.

The power supplied to the portable device may be cut off if the temperature of the portable device or the temperature of the battery is equal to or greater than a critical temperature.

The power supplied to the portable device may be cut off if at least one of temperature changes in the portable device, the battery and the external air per unit time, is greater than or equal to a preset reference value.

The method may further comprise controlling the battery to stop being charged or discharged depending on at least one of the determined temperatures.

Embodiments of the present general inventive concept can also be achieved by a portable device which receives power from a battery that may include a temperature determining unit to determine a temperature thereof, a temperature of the battery, and a temperature of the surrounding environment, and a control system which controls receiving power from the battery based on at least one of the temperatures determined.

The control system may include a power unit to receive power from the battery and to apply the power to the portable device, and a central processing unit.

The central processing unit may control the power unit to cut off power supplied to the portable device if at least one of the temperature of the portable device, the temperature of the battery and the temperature of the surrounding environment is greater than or equal to a critical temperature.

The central processing unit may control the power unit to cut off power supplied to the portable device if at least one of the temperature changes in the portable device, the battery, and the external air per unit time is greater than or equal to a preset reference value.

Embodiments of the present general inventive concept can also be achieved by providing a computer-readable medium to contain computer-readable codes providing commands for computers to execute a process that may include determining a temperature of a portable device, a temperature of a battery of the portable device, and a temperature of external air; and cutting off power to the portable device based on at least one of the determined temperatures.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIG. 1 is a control block diagram of a portable device and a battery according to an embodiment of the present general inventive concept;

FIG. 2 is a control flowchart of a portable device according to an exemplary embodiment of the present general inventive concept;

FIG. 3 is a control flowchart of a portable device according to another exemplary embodiment of the present general inventive concept; and

FIG. 4 is a control flowchart of a portable device according to yet another exemplary embodiment of the present general inventive concept.

### DETAILED DESCRIPTION

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, a portable device and a battery according to an embodiment of the present general inventive concept will be described in detail.

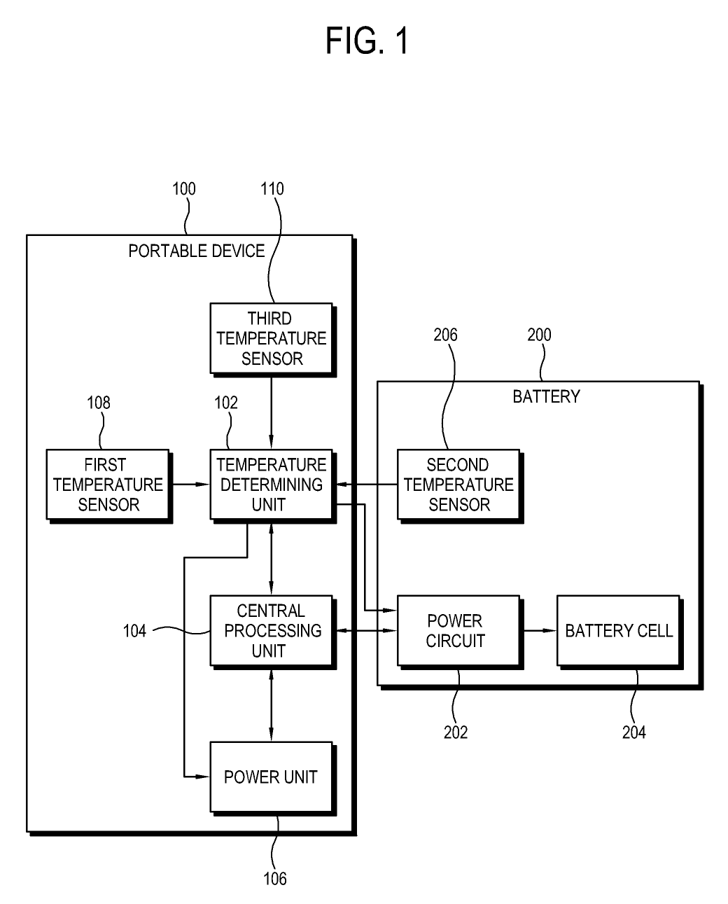

FIG.1 is a control block diagram of the portable device and the battery according to an embodiment of the present general inventive concept.

A portable device 100 refers to an electronic portable device such as a notebook computer, a laptop computer, a cellular phone, a personal digital assistant (PDA), a digital camera, a portable MP3 player, a portable DVD player, and the like.

The portable device 100 may include a temperature determining unit 102, a central processing unit 104, and a power unit 106.

The temperature determining unit 102 determines a temperature of the portable device 100, a temperature of the battery 200 and a temperature of external air. In this case, the temperature determining unit 102 may directly determine a temperature of the battery 200 or indirectly determine a temperature of the battery 200 by receiving the temperature of the battery 200 through communication with the battery 200.

If the temperature determining unit 102 directly determines a temperature of the battery 200, it may read the temperature sensed by respective temperature sensors of the portable device 100 and the battery 200. To this end, the portable device 100 may include a first temperature sensor 108 to sense its own temperature and a third temperature sensor 110 to sense a temperature of the external air. Moreover, the battery 200 may include a second temperature sensor 206 to sense its own temperature.

Meanwhile, the third temperature sensor 110 may be attached to the outside of the portable device 100 to be exposed to air.

In this case, the first, second and third temperature sensors 108, 206 and 110 may each include a thermistor which is a semiconductor element to measure a temperature corresponding to resistance.

If the temperature determining unit 102 indirectly determines the temperature of the battery 200, the portable device 100 may receive information about the temperature of the battery 200 through a system management bus (SMBus) communication with the battery 200. Power control between the portable device 100 and the battery 200 is performed through a SMBus. Thus, the temperature determining unit 102 may receive information about the temperature of the battery 200 through a communication interface, such as a SMBus, instead of directly sensing the temperature of the battery 200 through the temperature sensor. However, since the SMBus is a two-line simple bus used for communicating with low speed devices on a mother board, there are limitations, such as communication speed, communication subject, etc. For example, due to limited communication speeds, the temperature of external air may reach a dangerous level before the information about the temperature of the battery 200 is received from the battery 200. Thus, if the temperature determining unit 102 directly senses the temperature of the battery 200, as opposed to indirectly sensing the temperature, the portable device 100 may be more stable against a dangerous situation. A dangerous situation may occur when there is an increased likelihood of an accident, such as a battery explosion, due to high temperatures.

The central processing unit 104 controls the portable device 100 and the battery 200 according to the temperatures determined by the temperature determining unit 102, i.e., according to the temperature of the portable device 100, the temperature of the external air and the temperature of the battery 200.

More specifically, the central processing unit 104 may control the power unit 106 to cut off power to the portable device 100 if the determined temperature of the external air reaches a preset temperature.

If the determined temperature of the external air reaches a preset temperature, the central processing unit 104 may also control the battery 200 to stop being charged or discharged. In this case, the central processing unit 104 outputs a charging suspension signal or a discharging suspension signal to a power circuit 202 of the battery 200.

The power unit 106 shuts down the portable device 100 by cutting off the power based on a control of the central processing unit 104.

A power supply source of the power unit 106 may include the battery 200. The power unit 106 may control the power to the portable device 100 by receiving the power from the battery 200.

The battery 200 may supply power to the portable device 100, and be attached to or detached from the portable device 100. The battery 200 may include the power circuit 202 and a battery cell 204.

The power circuit 202 controls the battery cell 204 to stop being charged or discharged according to a control of the central processing unit 104. More specifically, the power circuit 202 turns off a charging switch according to a charging suspension signal outputted from the central processing unit 104 of the portable device 100. Similarly, the power circuit 202 turns off a discharging switch according to a discharging suspension signal outputted from the central processing unit 104 of the portable device 100.

The battery cell 204 stops being charged or discharged according to a control of the power circuit 202. The battery cell 204 may include a common chargeable/dischargeable cell. For example, the battery cell 204 may include a nickel-cadmium battery, a lead storage battery, a nickel-hydrogen battery, a lithium-ion battery, a lithium polymer battery or a lithium metal battery, a zinc air battery, and the like. A single or a plurality of battery cells 204 may be used. The plurality of battery cells 204 may be connected in series or in parallel.

Meanwhile, the battery 200 may include a second temperature sensor 206 to sense a temperature of the battery 200, which is mentioned above.

Hereinafter, a control method of the portable device 100 and the battery 200 will be described in detail.

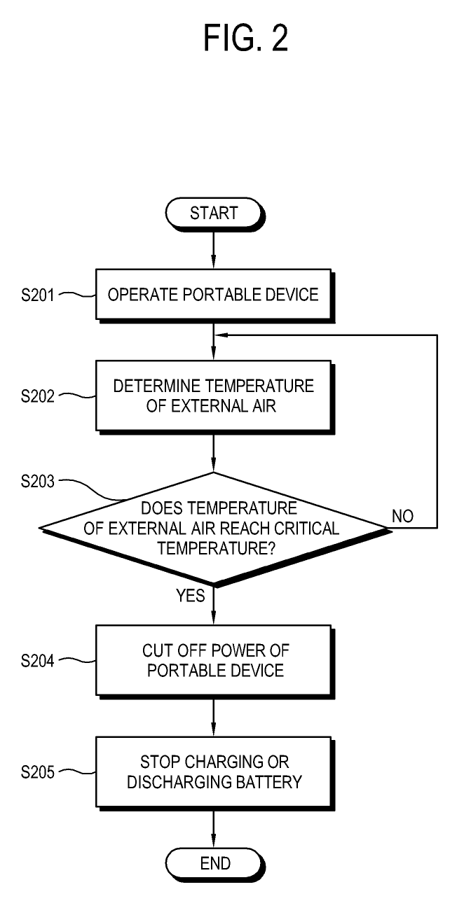

FIG. 2 is a control flowchart of the portable device 100 according to an exemplary embodiment of the present general inventive concept.

The portable device 100 may be influenced by not only its own temperature and the temperature of the battery 200, but also the temperature of external air. Thus, the portable device 100 according to the present exemplary embodiment of the present invention considers the temperature of external air.

While the portable device 100 operates (operation S201), it determines the temperature of external air (operation S202).

In this exemplary embodiment, the portable device 100 determines whether the temperature of the external air reaches a critical temperature (operation S203). The critical temperature refers to a previously set temperature at which the portable device 100 enters a dangerous situation. The critical temperature of the portable device 100 may be set by a user or set as a default by a manufacturer.

Further, the critical temperature may be set in consideration of factors which can affect the safety of the portable device 100 and the battery 200. Such factors may include, but are not limited to, the specification and the environment of the portable device and the battery, and the like.

For example, the temperature of the portable device 100 at a maximum load varies depending on storage capacity of the portable device 100. As a result, each portable device 100 has a different critical temperature of external air at which it faces a dangerous situation.

The critical temperature of external air at which the portable device 100 faces a dangerous situation may vary depending on the environment where the portable device 100 is being used. For example, when the portable device 100 or the battery 200 are negatively affected by electromagnetic energy, the critical temperature of the external air of the portable device 100 is lowered. In other words, the critical temperature may vary as a result of other factors such as the environment where the portable device 100 is being used.

Thus, the portable devices 100 can set different critical temperatures of the external air based on a variety of factors. When the temperature of the external air reaches the critical temperature, the portable device 100 controls itself and the battery 200 regardless of the temperature of the portable device 100 and the temperature of the battery 200.

If the temperature of the external air does not reach the critical temperature, the portable device 100 goes back to the operation S202 and continues to monitor the temperature of the external air.

If it is determined that the temperature of the external air reaches the critical temperature (operation S203), the portable device 100 shuts down the system by cutting off power to the portable device 100 (operation S204) in order to prevent a dangerous situation due to high temperatures. The portable device 100 similarly controls the battery 200 to stop being charged or discharged (operation S205).

According to embodiments of the present general inventive concept, the portable device 100 can control itself or the battery 200 selectively. That is, either the control to cut-off the power to the portable device 100 or the control to suspend the discharge of the battery 200 may be performed, or the foregoing two operations may be performed at the same time. If the portable device 100 and the battery 200 are controlled at the same time, accidents that occur while the portable device 100 is using the battery 200 may be prevented more effectively.

While the temperatures of the portable device 100 and the battery 200 are stable at safe temperatures, the temperature of the external air may drastically rise. According to the previous exemplary embodiment of the present general inventive concept, accidents due to the temperature of the external air may be prevented regardless of the status of the portable device 100 and the battery 200.

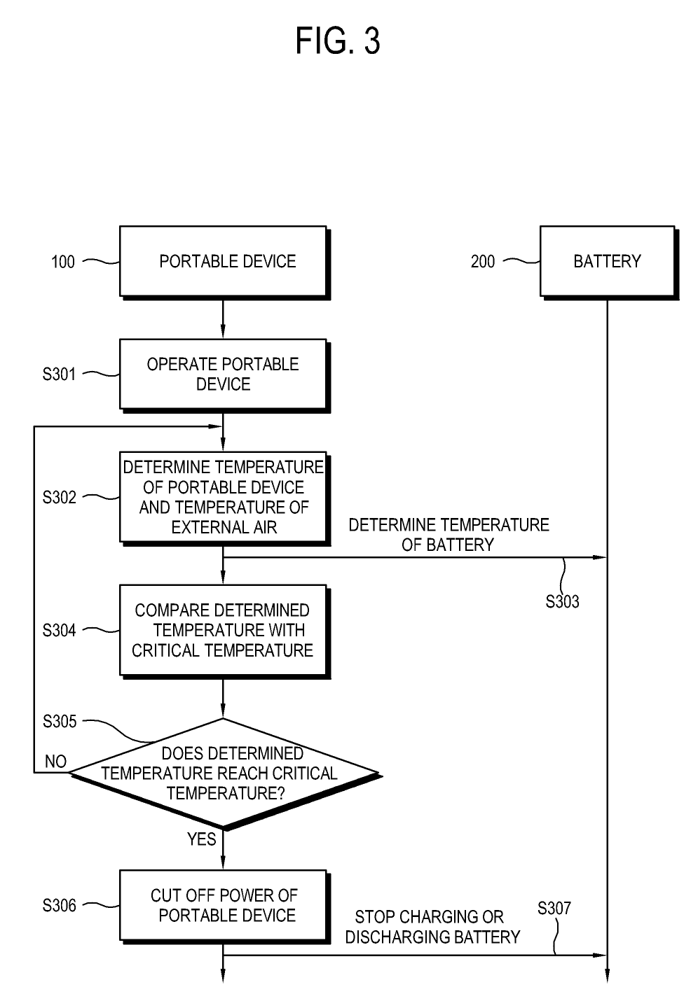

FIG. 3 is a control flowchart of a portable device according to another exemplary embodiment of the present general inventive concept.

Synergy among the portable device 100, the battery 200 and external air may accelerate a dangerous situation. For example, if the temperature of the portable device 100 and the temperature of external air rise at the same time, the synergy therebetween may accelerate a dangerous situation. Accordingly, the control method in FIG. 3 considers the temperature of the battery 200, the temperature of the portable device 100, and the temperature of external air at the same time in controlling the portable device 100 and the battery 200.

While the portable device 100 operates (operation S301), a temperature determining unit 102 determines a temperature of the portable device 100 and a temperature of external air (operation S302). At the same time, the temperature determining unit 102 determines a temperature of the battery 200 (operation S303).

The portable device 100 compares the actual temperatures determined by the temperature determining unit 102 with critical temperatures (operation S304).

The critical temperature may be set based on experiments that take into consideration the correlation among the portable device 100, the battery 200 and the external air. For example, a temperature of the portable device 100 and the battery 200 that, when combined, increase the likelihood of a dangerous situation with regard to the temperature of the external air, this combined temperature may be set as a critical temperature. Similarly, a temperature of the battery 200 and the external air that, when combined increase the likelihood of a dangerous situation with regard to the temperature of the portable device 100, this combined temperature may be set as a critical temperature. Additionally, a temperature of the portable device 100 and the external air that, when combined, increase the likelihood of a dangerous situation with regard to the temperature of the battery 200, this combined temperature may be set as a critical temperature.

A critical temperature may be set based on the combination of two of the temperature of the portable device 100, the temperature of the battery 200 and the temperature of the external air, if a combined temperature that is greater than or equal to the critical temperature increases the potential for a dangerous situation to occur with respect to temperature.

The portable device 100 determines whether the determined temperature reaches the critical temperature (operation S305). That is, if the determined temperature reaches one of the critical temperatures set according to various criteria as described above, the portable device 100 determines that it faces a dangerous situation.

If the determined temperature is equal to or greater than the critical temperature, the portable device 100 shuts down the system by cutting off power to the portable device 100 (operation S306). The portable device 100 controls the battery 200 to stop being charged or discharged (operation S307). In this case, the portable device 100 or the battery 200 may be controlled selectively as shown in FIG. 2.

If the determined temperature is less than the critical temperature, the portable device 100 goes back to the operation S302 and continues to monitor the temperature of the battery 200, the temperature of the portable device 100 and the temperature of the external air.

Even if the respective temperatures of the external air, the portable device 100 and the battery 200 are not so high as to make a dangerous situation more likely to occur, they may face a dangerous situation due to synergy. According to the present exemplary embodiment of the present general inventive concept, a dangerous situation due to the synergy among the portable device 100, the battery 200 and the external air may be prevented.

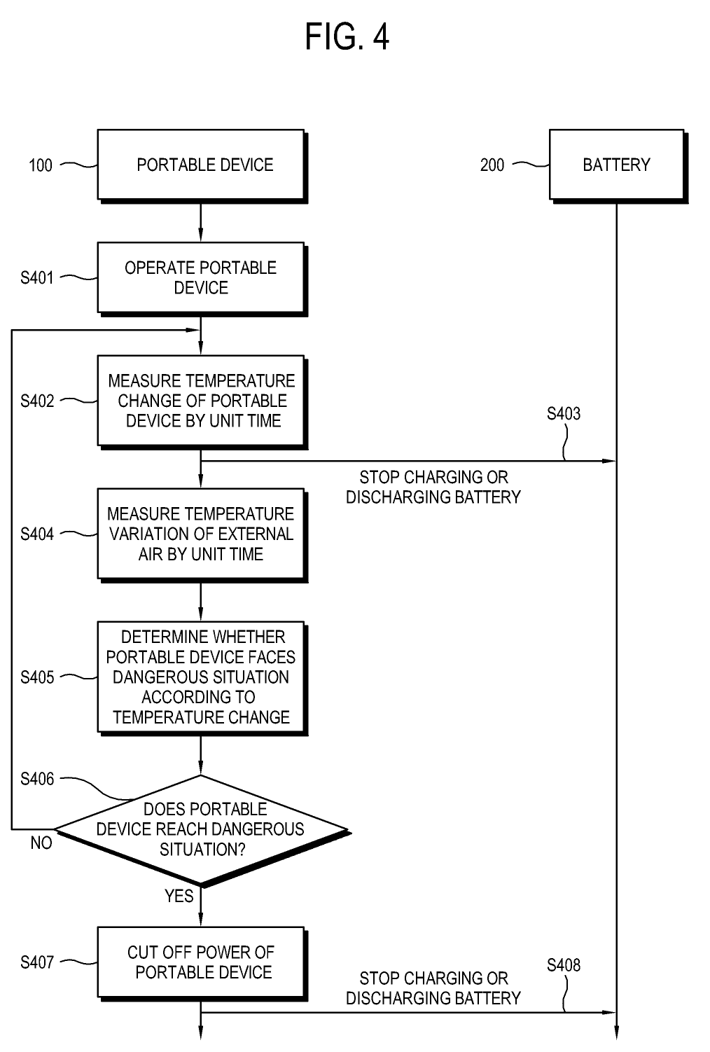

FIG. 4 is a control flowchart of a portable device according to yet another exemplary embodiment of the present general inventive concept.

If a portable device 100 is used in abnormal environment, i.e., if it does not operate in a normal environment, accidents may occur. According to experiments, the temperature of the portable device 100 (e.g., a notebook computer) and the battery 200 rises by 30 degrees or more when used in closed space (for example, on bedding, an electric blanket, a bag, etc.) than in normal environment. A normal environment, in the case of a notebook computer, may include, but is not limited to, a desk, a table, etc. In this case, it takes considerable time to lower the temperature to a safe level, and the portable device 100 may face a dangerous situation.

To prevent such a dangerous situation, the portable device 100 and the battery 200, according to the present exemplary embodiment of the present general inventive concept, are controlled depending on changes in the temperature of the portable device 100, the temperature of the battery 200 and the temperature of the external air. That is, if the changes in the temperature of the portable device 100, the temperature of the battery 200 and the temperature of the external air are drastic compared with a preset reference value, it is determined that the portable device 100 or the battery 200 operates in abnormal environment.

While the portable device 100 operates (operation S401), it determines the changes in the temperature of the portable device 100 per unit time (operation S402) and measures the changes in the temperature of the battery 200 per unit time (operation S403). At the same time, the portable device 100 measures the changes in the temperature of the external air per unit time (operation S404).

The portable device 100 determines whether it faces a dangerous situation (operation S405) according to the measured temperature changes. More specifically, the portable device 100 compares the measured changes in the temperature with the preset reference value, and determines whether the portable device 100, the battery 200 and the external air exhibit temperature change that suggests an abnormal environment or situation. For example, if at least one among the temperatures of the external air, the portable device 100 and the battery 200 changes drastically, it may be determined that the portable device 100 is in an abnormal situation. That is, if at least one of the temperature changes of the portable device 100, the battery 200 and the external air per unit time is equal to or greater than the preset reference value, it is determined that the portable device 100 operates in abnormal environment.

If it is determined that the portable device 100 operates in the abnormal environment and faces a dangerous situation (operation S406), the portable device 100 shuts down the system by cutting off power to the portable device 100 (operation S407). The portable device 100 controls the battery 200 to stop being discharged (operation S408). In this case also, the portable device 100 or the battery 200 may be controlled selectively.

If it is determined that the portable device 100 does not face a dangerous situation, the portable device 100 goes back to the operation S402 and continues to monitor the changes in the temperature of the portable device 100, the temperature of the battery 200 and the temperature of the external air.

According to the present general inventive concept, a dangerous situation due to various factors regarding a portable device using a battery may be prevented.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, Blu-Ray discs, magnetic tapes, floppy disks, optical data storage devices, and the like. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the invention, the scope of which is defined in the appended claims and their equivalents.

What is claimed is:

1. A portable device which receives power from a battery, the portable device comprising:
a temperature determining unit which determines a temperature of the portable device, a temperature of the battery and a temperature of external air;
a power unit which receives power from the battery and applies the power to the portable device; and
a central processing unit which controls the power unit to cut off power to the portable device, based on at least one of the determined temperatures.

2. The portable device according to claim 1, wherein the temperature determining unit directly determines the temperature of the battery or indirectly determines the temperature of the battery received through communication between the central processing unit and the battery.

3. The portable device according to claim 1, wherein the central processing unit controls the power unit to cut off power supplied to the portable device if the temperature of the external air is greater than or equal to a preset temperature.

4. The portable device according to claim 1, wherein the central processing unit controls the power unit to cut off power supplied to the portable device if the temperature of the portable device or the temperature of the battery is greater than or equal to a critical temperature.

5. The portable device according to claim 1, wherein the central processing unit controls the power unit to cut off power supplied to the portable device if at least one of temperature changes in the portable device, the battery and the external air per unit time is greater than or equal to a preset reference value.

6. The portable device according to claim 1, wherein the central processing unit controls the battery to stop being charged or discharged depending on at least one of the determined temperatures.

7. A system which has a battery and a portable device, the system comprising:
a portable device which determines a temperature of the portable device, a temperature of the battery and a temperature of external air, and controls the battery to stop being charged or discharged depending on at least one of the determined temperatures; and
a battery which supplies power to the portable device, and stops being charged or discharged according to a control of the portable device.

8. The system according to claim 7, wherein the portable device cuts off power based on at least one of the determined temperatures.

9. A control method of a portable device which receives power from a battery, the control method comprising:
determining a temperature of the portable device, a temperature of the battery and a temperature of external air; and
cutting off power to the portable device based on at least one of the determined temperatures.

10. The control method according to claim 9, wherein the determining of the temperature of the battery comprises:
directly determining the temperature of the battery; or
indirectly determining the temperature of the battery received through communication between a central processing unit and the battery.

11. The control method according to claim 9, wherein the power supplied to the portable device is cut off if the temperature of the external air is greater than or equal to a preset temperature.

12. The control method according to claim 9, wherein the power supplied to the portable device is cut off if the temperature of the portable device or the temperature of the battery is equal to or greater than a critical temperature.

13. The control method according to claim 9, wherein the power supplied to the portable device is cut off if at least one of temperature changes in the portable device, the battery and the external air per unit time is greater than or equal to a preset reference value.

14. The control method according to claim 9, further comprising:
controlling the battery to stop being charged or discharged depending on at least one of the determined temperatures.

15. A portable device which receives power from a battery, the portable device comprising:
a temperature determining unit to determine a temperature thereof, a temperature of the battery, and a temperature of the surrounding environment; and
a control system which controls receiving power from the battery based on at least one of the temperatures determined.

16. The portable device according to claim 15, wherein the control system includes a power unit to receive power from the battery and apply the power to the portable device, and a central processing unit.

17. The portable device according to claim 16, wherein the central processing unit controls the power unit to cut off power supplied to the portable device if at least one of the temperature of the portable device, the temperature of the battery and the temperature of the surrounding environment is greater than or equal to a critical temperature.

18. The portable device according to claim 16, wherein the central processing unit controls the power unit to cut off power supplied to the portable device if at least one of the temperature changes in the portable device, the battery, and the external air per unit time is greater than or equal to a preset reference value.

19. The portable device according to claim 16, wherein the central processing unit controls the battery to stop being charged or discharged depending on at least one of the determined temperatures.

20. A computer-readable medium to contain computer-readable codes providing commands for computers to execute a process including:
determining a temperature of a portable device, a temperature of a battery of the portable device, and a temperature of external air; and
cutting off power to the portable device based on at least one of the determined temperatures.
